(19) United States
(12) Patent Application Publication
(10) Pub. No.: US 2003/0234878 A1
(43) Pub. Date: Dec. 25, 2003

(54) Digital camera with voice interface

(76) Inventor: Chin-Hsin Yang, Taipei Hsien (TW)

Correspondence Address: FISH & RICHARDSON PC, 225 FRANKLIN ST, BOSTON, MA, 02110, US

(21) Appl. No.: 10/175,262

(22) Filed: Jun. 19, 2002

(51) Int. Cl. H04N 5/76; H04N 5/262

(52) U.S. Cl. 348/231.4; 348/239

(57) ABSTRACT

A digital camera with a voice interface. The digital camera with a voice interface of the present invention comprises a digital camera body having a plurality of functional options and corresponding functions, a one-button input unit coupled to the digital camera body for producing a group of control signals, a control unit coupled to the one-button input unit to select the plurality of functional options and to perform the corresponding functions according to the group of control signals, and to output a corresponding audio signal according to each of the functional options and functions, and a voice output unit coupled to the control unit to indicate which the functional options is selected and which function is performed.

### BACKGROUND OF THE INVENTION

1. Field of the Invention

The present invention relates in general to a digital camera, in particular, the present invention relates to a digital camera with voice interface.

2. Description of the Related Art

Conventionally, a digital camera at least comprises a digital camera body, a plurality of control buttons, and a liquid crystal display. Furthermore, the plurality of control buttons at least comprises a select-button and an OK-button. Users operate the functions of the digital camera by manipulating the select-button and the OK-button and viewing the results on the liquid crystal display.

However, the liquid crystal displays are expensive and make up a significant part of the cost of the camera. In addition, manipulating two or more buttons to operate camera functions is sometimes difficult or confusing. A need therefore exists for an inexpensive digital camera that is more user-friendly then the conventional digital camera.

### SUMMARY OF THE INVENTION

An object of the present invention is to provide a digital camera that can control all the functions thereof with one on button and broadcast the states of the camera by a voice unit. Because the functions of the digital camera of the present invention can be controlled by a single button, the camera is user-friendly. In addition, because a voice unit is used to broadcast the state of the camera instead of a liquid crystal display, the size of the digital camera can be decreased and the cost reduced.

According to the object, a digital camera with voice interface of the present invention comprises a digital camera body having a plurality of functional options and corresponding functions, a one-button input unit coupled to the digital camera body for producing a group of control signals, a control unit coupled to the one-button input unit to select from the plurality of functional options and to perform the corresponding functions according to the group of control signals, and to output a corresponding audio signal according to each of the functional options and functions, and a voice output unit coupled to the control unit to indicate which the functional options is selected and which of the functions is performed.

The present invention also provides a method of controlling functions of a digital camera with a single button. In the method of the present invention, an input signal is determined one of a first control signal and a second control signal according to how long has the button been pressed. The functional option is selected and a first corresponding audio signal is outputted when the input signal is the first control signal, the function is performed and a second corresponding audio signal is outputted when the input signal is the second control signal.

### BRIEF DESCRIPTION OF THE DRAWINGS

FIG. 1 is a schematic diagram illustrating the digital camera with voice interface of the present invention.

FIG. 2 shows a process flow according to the control method of the present invention.

FIG. 3 is a schematic diagram illustrating the operation of the digital camera according to the present invention.

### DETAILED DESCRIPTION OF THE INVENTION

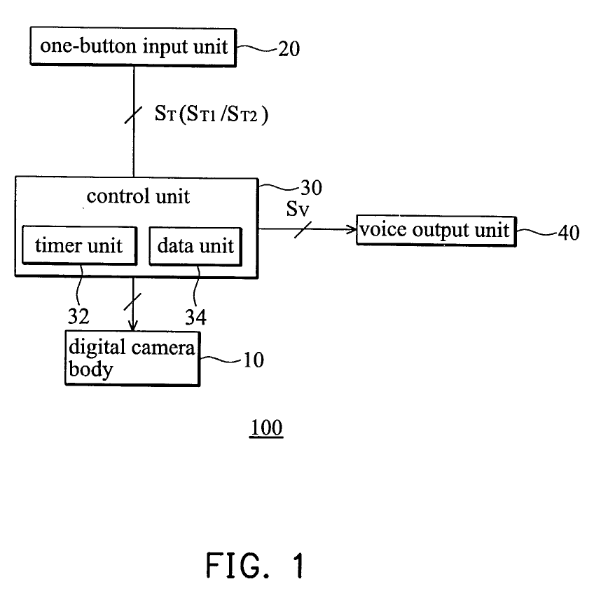

FIG. 1 is a schematic diagram illustrating the digital camera with voice interface of the present invention. In FIG. 1, a digital camera with voice interface 100 has a digital camera body 10, a one-button input unit 20, a control unit 30 and a voice output unit 40. The control unit 30 further composes a timer 32 and a data unit 34.

The digital camera body 10 has a plurality of functional options and corresponding functions. For example, the functional options may be, for example, acquiring image, erasing image, transferring image, voice speed adjustment, power on functional option and power off.

The one-button input unit 20 is coupled to the digital camera body 10 to produce a group of control signals ST. In this embodiment, the group of control signals ST comprises a first signal ST1 and a second signal ST2.

The control unit 30 is coupled to the one-button input unit 20 to select the functional options of the digital camera 10 and to perform the corresponding functions according to the group of control signals ST. The control unit 30 outputs a corresponding audio signal according to each of the functional options and functions. For example, when the control unit 30 selects an “acquiring image” functional option according to the group of control signals, the control unit 30 further outputs an audio signal corresponding to the “acquiring image” function option. In another case, when the control unit 30 selects an “erasing image” functional option according to the group of control signals, the control unit 30 further outputs an audio signal corresponding to the “erasing image” function option.

Furthermore, the control unit 30 further comprises a timer 32 to count how long the one-button input unit 20 has been pressed. The control unit 30 determines an input signal is the first signal ST1 if the one-button input unit 20 is pressed over a first determined time, and determines the input signal is the second signal ST2 if the one-button input unit 20 is pressed over a second determined time, wherein the second determined time is longer than the first determined time. For example, the control unit 30 determines an input signal is the first signal ST1 when the one-button input unit 20 is pressed less than one second, and the control unit 30 determines the input signal is the second signal ST2 when the one-button input unit 20 is pressed over than one second. Moreover, the control unit 30 further has a data unit 34 coupled to the digital camera body 10 to store audio signal corresponding to the plurality of functional options and functions of the digital camera body 10.

The voice output unit 40 is coupled to the control unit 30 to broadcast a first audio signal when a functional option is selected, and to broadcast a second audio signal when a function is performed. For example, the voice output unit 40 is a speaker. When the control unit 30 selects an “acquiring image” functional option according to the group of control signals ST and outputs an audio signal corresponding to the “acquiring image” functional option, the voice output unit 40 broadcasts the word “CAMERA” after receiving the audio signal to inform user that the “acquiring image” functional option is selected. In another case, when the control unit 30 performs an “erasing image” function according to the group of control signals ST and outputs a audio signal corresponding to the “erasing image” function, the voice output unit 40 broadcasts the word “ERASE” after receiving the audio signal to inform user that the “erasing image” functional is performed.

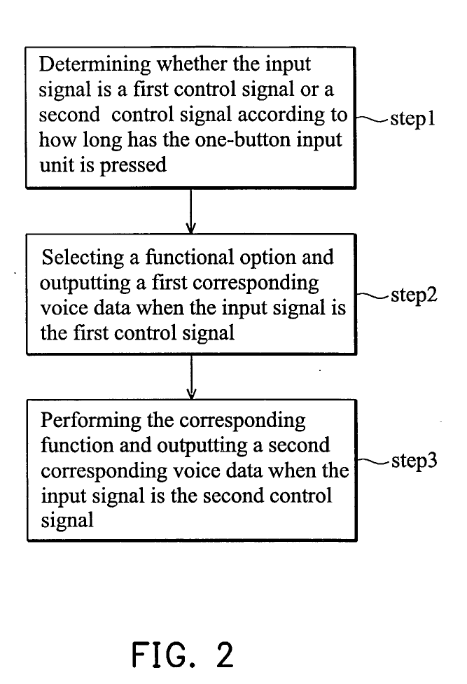

FIG. 2 shows a process flow according to the control method of the present invention. The present invention provides a method of controlling functions of a digital camera with a single button. In step 1 of the present invention, an input signal is determined one of a first control signal and a second control signal according to how long has the button been pressed. Next, in step 2, a functional option is selected and a first corresponding audio signal is outputted when the input signal is the first control signal. In step 3, a function is performed and a second corresponding audio signal is outputted when the input signal is the second control signal.

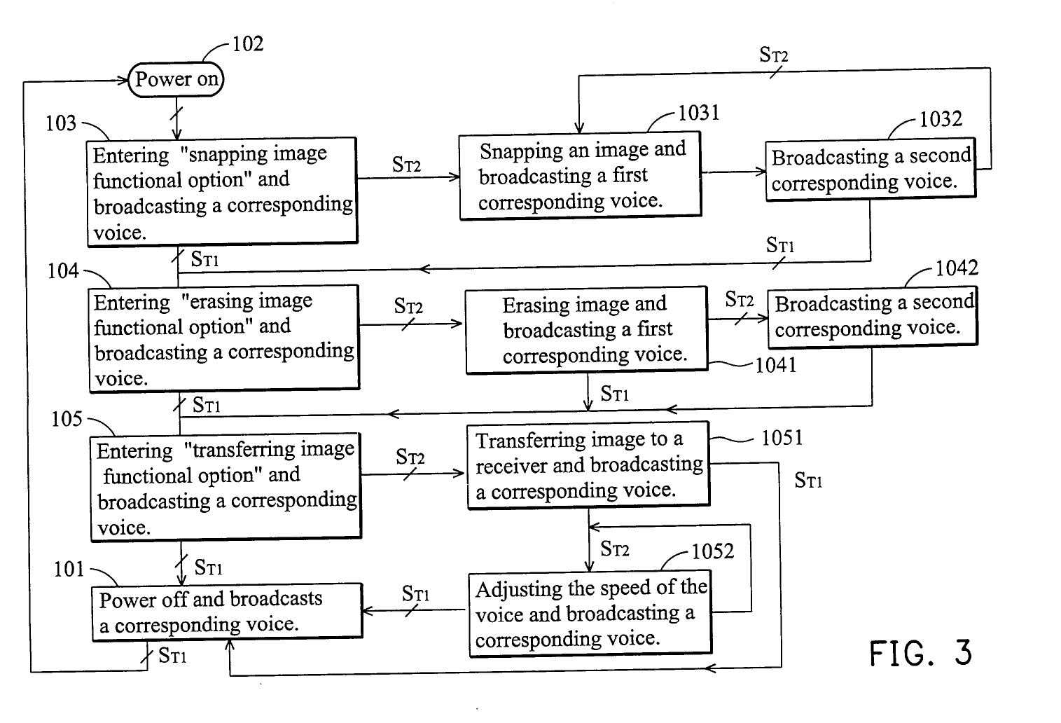

FIG. 3 is a schematic diagram illustrating the operation of the digital camera according to the present invention.

In this embodiment of the present invention, the control unit 30 determines an input signal is the first signal ST1 when the one-button input unit 20 is pressed for less than one second, and the control unit 30 determines the input signal is the second signal ST2 when the one-button input unit 20 is pressed for over one second. The plurality of functional options of the digital camera 100 may include, for example, power off, snapping image, erasing image, transferring image, voice speed adjustment and power off.

Initially, the digital camera 100 is assumed in power off state. Then steps 102 and 103 are performed when receiving a first signal ST1. In the step 102, the digital camera 100 is turned on, and then the control unit 30 selects to the “acquiring image” functional option and broadcasts a corresponding voice, for example, “CAMERA” and “the number of picture that has been acquired”, in the step 103.

Steps 1031 and 1032 are performed when receiving a second signal ST2 after the step 103. Alternately, step 104 is performed when receiving another first signal ST1 after the step 103. In the step 1031, digital camera 100 acquires an image and the voice output unit 40 broadcasts a first corresponding voice, for example “snap” to inform user that which function is being performed. In the step 1032, the voice output unit broadcasts a second corresponding voice, for example “four”, to inform user how many images have been acquired.

Then step 1031 is performed again when receiving another second signal ST2 after the step 1032. Alternately, the step 104 is performed when receiving a first signal ST1 after the step 1032. In the step 104, the control unit 30 selects an “erasing image” functional option and broadcasts a corresponding voice, for example, “ERASE”.

Then step 1041 is performed when receiving one another second signal ST2 after the step 104. Alternately, the step 105 is performed when receiving another first signal ST1 after the step 104. In the step 1041, the voice output unit 40 broadcasts a first corresponding voice, for example “ARE YOU SURE”?

Then step 1042 is performed when receiving another second signal ST2 after the step 1041. Alternately, the step 105 is performed when receiving another first signal ST1 after the step 1041. In the step 1042, the digital camera 100 erases the pictures in the camera, and the voice output unit 40 broadcasts a second corresponding voice, for example “OK” or “FINISH”.

In the step 105, control unit 30 selects a “transferring image” functional option and the voice output unit broadcasts a corresponding voice, for example “TRANSFER”. Then step 1051 is performed when receiving another second signal ST2 after the step 105. Alternately, the step 101 is performed when receiving another first signal ST1 after the step 105.

In the step 1051, the digital camera 100 transfers pictures therein to a receiver (not shown) and the voice output unit broadcasts a corresponding voice, for example “DOWNLOAD”. Then step 1052 is performed when receiving another second signal ST2 after the step 1051. Alternately, the step 101 is performed when receiving one another first signal ST1 after the step 1051.

In the step 1052, the digital camera adjusts the frequency of the voice output, for example from 50 Hz to 60 Hz or from 60 Hz to 50 Hz. The voice output unit 40 broadcasts a corresponding voice, for example 50 Hz, to inform user which speed is selected. Then step 1052 is performed again when receiving another second signal ST2 after the step 1052. Alternately, the step 101 is performed when receiving another first signal ST1 after the step 1052.

In the step 101, the digital camera 100 turns off and the voice output unit 40 broadcasts a corresponding voice, for example “POWER OFF”.

The control of the digital camera of the present invention is user-friendly because all functions of the camera can be controlled by one button. In addition, the present invention replaces the liquid crystal display of the conventional with a voice unit to broadcast the state of the camera. This reduces the size of the digital camera and decreases the cost of the liquid crystal display.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A digital camera with a voice interface, comprising:
a digital camera body having a plurality of functional options and corresponding functions;
a one-button input unit coupled to the digital camera body for producing a group of control signals;
a control unit coupled to the one-button input unit to select the plurality of functional options and to perform the corresponding functions according to the group of control signals, and to output a corresponding audio signal according to each of the functional options and functions; and
a voice output unit coupled to the control unit to indicate which the functional options is selected and which function is performed.

2. The digital camera with a voice interface as claimed in claim 1, wherein the group of control signals is composed of a first control signal and a second control signal.

3. The digital camera with a voice interface as claimed in claim 2, wherein the control unit is a micro processor.

4. The digital camera with a voice interface as claimed in claim 1, wherein the control unit further comprises a timer for counting how long has the one-button input unit been pressed, wherein the control unit determines the control signal is the first control when the one-button input unit is pressed less a first predetermined time, and the control unit determines the control signal is the first control when the one-button input unit is pressed over the first predetermined time.

5. The digital camera with a voice interface as claimed in claim 4, wherein the control unit further comprises a data unit coupled to the control unit to store the audio signal.

6. The digital camera with a voice interface as claimed in claim 5, wherein the voice output unit is a speaker or a buzzer.

7. The digital camera with a voice interface as claimed in claim 1, wherein the functional options are included of acquiring image, erasing image, transferring image, voice speed adjustment, power on and power off.

8. A method of controlling functions of a digital camera by a button, comprise:
determining whether an input signal is one of a first control signal and a second control signal according to how long has the button been pressed;
selecting the functional option and outputting a first corresponding audio signal when the input signal is the first control signal; and
performing the function and outputting a second corresponding audio signal when the input signal is the second control signal.
